(19) United States
(12) Patent Application Publication
(10) Pub. No.: US 2006/0258301 A1
(43) Pub. Date: Nov. 16, 2006

(54) Mobile communication terminal and method

(76) Inventors: Yanqing Cui, Jiu Qu town (CN); Morten Proschowsky, Frederiksberg (DK)

Correspondence Address: PERMAN & GREEN, 425 POST ROAD, FAIRFIELD, CT, 06824, US

(21) Appl. No.: 11/128,439

(22) Filed: May 12, 2005

(51) Int. Cl. H04B 1/38; H04M 1/00

(52) U.S. Cl. 455/90.3; 455/575.1

(57) ABSTRACT

A mobile communication apparatus is disclosed, comprising a processor and a user interface UI connected to said processor, wherein said UI comprises a rotator input comprising a first sensor means comprising an output providing a start signal indicating where on the rotator input a user starts to actuate said rotator input, and a second sensor means comprising an output providing a rotation signal indicating an amount of rotation of said rotator input; said processor is arranged to navigate to an item of a plurality of items in said UI according to a function of said start signal and said rotation signal; and said UI further comprises a display on which said item is presented. Further, a method for input for the mobile communication apparatus is disclosed.

### TECHNICAL FIELD

The present invention relates to a mobile communication apparatus, and a method for input with a rotator input of a user interface of said mobile communication apparatus.

### BACKGOUND OF THE INVENTION

A rotator input is used in many applications, from microwave ovens to mp3-players, as for example the popular iPod by Apple Computer, Inc. A rotator input provides a two-way navigation for selecting among a plurality of pre-defined items. For example, on a microwave oven, the items comprises a plurality of feasible times for heating being presented on a display while turning the rotator input. When a time that satisfies the user appears, the user can select the time. There are other applications where the list of items is long, and the demand on a quick input is high, e.g. in mobile communication apparatuses where a user may be occupied with other activities at the same time, e.g. hurrying to a meeting, driving a car or walking in the street, as making her inputs. When navigating through a long list, a lot of attention is drawn to the input and the input may take a considerable time. In US patent application with publication no. US2004/0253931, it is disclosed a mobile communication device comprising a rotator input device. The rotator element is supported by a keypad so as to allow for a plurality of short cut actions to be taken without having to toggle through any menus displayed on a display. However, there is a need for an improved input in relation to rotator inputs of a mobile communication apparatus.

### SUMMARY OF THE INVENTION

In view of the above, an objective of the invention is to solve or at least reduce the problems discussed above. In particular, an objective is to provide improved input for a mobile communication apparatus.

The above object is achieved according to a first aspect of the present invention by a mobile communication apparatus, comprising a processor and a user interface UI connected to said processor, wherein said UI comprises a rotator input comprising a first sensor means comprising an output providing a start signal indicating where on the rotator input a user starts to actuate said rotator input, and a second sensor means comprising an output providing a rotation signal indicating an amount of rotation of said rotator input; said processor is arranged to navigate to an item of a plurality of items in said UI according to a function of said start signal and said rotation signal; and said UI further comprises a display on which said item is presented.

An amount of rotation should be construed as any amount indicating rotation, such as a fractional turn, an angle of rotation, continous or discrete values obtained by a rotation sensor, etc.

An advantage of this is a faster, easier, and more user friendly user interface.

The rotator input may be divided into a plurality of sectors, wherein each sector is associated with a start signal.

The first sensor means may be touch sensitive.

The function may comprise a sub-function of said start signal indicating a starting point in a list of items, and said rotation signal indicating a number of steps from said starting point in said list.

The items may be characters to be selected for input of characters.

The subfunction of said start signal may determine a most probable character to be input to be said starting point of said list of items. The most probable character may be determined from said start signal and previously input characters.

The function may comprise a sub-function of said start signal indicating a scrolling speed among items, and said rotation signal indicating an amount of scrolling according to said scrolling speed.

The function may comprise a sub-function of said start signal indicating an operation mode.

The UI may be arranged to display a sub-set of said plurality of items, wherein said sub-set is associated with a value of said start signal.

The above object is achieved according to a second aspect of the present invention by a method for input with a rotator input of a user interface UI of a mobile communication apparatus, comprising the steps of: determining a starting position on said rotator input where a user starts actuating said rotator input, and rotation of said rotator input; navigating to an item of a plurality of items of said UI according to a function of said starting position and said rotation; and displaying said item.

The function may comprise a subfunction of said start signal indicating a starting point in a list of items, and said rotation signal indicating a number of steps from said starting point in said list.

The items may be characters to be selected for input of characters and the subfunction of said start signal may determine a most probable character to be input to be said starting point of said list of items. The most probable character may be determined from said start signal and previously input characters.

The items may be characters, further comprising the steps of selecting a character; and using the selected character as input.

The function may comprise a subfunction of said start signal indicating a scrolling speed among said plurality of items, and said rotation signal indicating an amount of scrolling according to said scrolling speed.

The function may comprise a subfunction of said start signal indicating an operation mode.

The method may further comprise the step of enabling a user to select the displayed item.

The method according may further comprise the step of displaying a sub-set of said plurality of items, wherein said sub-set depends on said starting position.

The above object is achieved according to a third aspect of the present invention by a mobile communication system comprising a network and a plurality of mobile communication apparatuses wirelessly being in communication with said network, wherein at least one of said mobile communication apparatuses has the features according to the mobile communication apparatus of the first aspect of the present invention.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one in-stance of said element, device, component, means, step, etc., unless explicitly stated otherwise. The steps of any method dis-closed herein do not have to be performed in the exact order disclosed, unless explicitly stated.

Other objectives, features and advantages of the present invention will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 schematically shows a mobile communication apparatus comprising a user interface UI with a rotator input and a display according to an embodiment of the present invention;

FIG. 2 schematically shows a mobile communication apparatus comprising a user interface UI with a rotator input and a display according to an embodiment of the present invention;

FIG. 3 is a schematic block diagram of a mobile communication apparatus;

FIG. 4 is a flow chart illustrating an input method for a mobile communication apparatus with a rotator input;

FIG. 5 shows assignment of characters to positions of a rotator input according to an embodiment of the present invention;

FIG. 6 schematically shows a mobile communication apparatus in use according to an embodiment of the present invention; and

FIG. 7 schematically shows a mobile communication system according to an embodiment of the present invention.

### DETAILED DESCRIPTION OF PREFERRED EMBODIMENTS

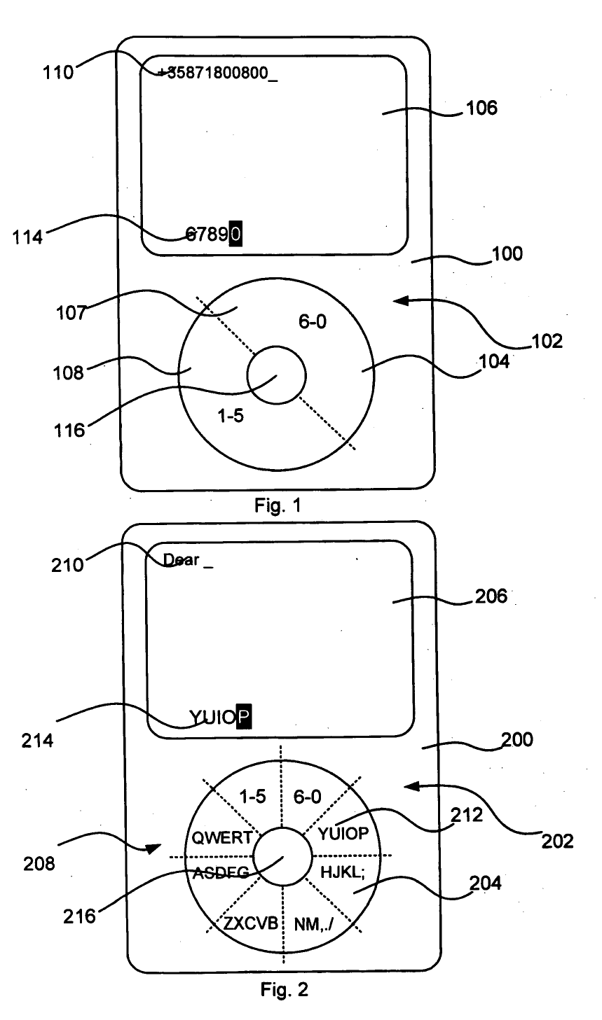

FIG. 1 schematically shows a mobile communication apparatus 100 comprising a user interface UI 102 with a rotator input 104 and a display 106 according to an embodiment of the present invention. The rotator input 104 can be mechanically rotatable or a touch pad arranged to sense a rotating movement of a user's finger around a center of the touch pad. The rotator input 104 is divided into two areas 107, 108 and comprises means for determining in which area the user starts to actuate the rotator input 104. In case the rotator input 104 is a touch pad, the starting point is determined to be the first detected position at an actuation. In case the rotator input 104 is mechanically rotatable, a sensor means can be arranged under the moving part of the rotator input 104 to record the starting position. Depending on the area in which the user starts to actuate the rotator input 104, and the amount of actuation, i.e. the angular movement detected by the rotator input 104, navigation is performed among items. In the example illustrated by the mobile communication apparatus 100 in FIG. 1, a telephone number 110 is input by using the rotator input 104, which is divided into two areas 107, 108; one for numerals “1-5” and one for numerals “6-0”. Here, the user has started actuating the rotator input 104 in the area 107 associated with numerals “6-0” and navigated among these numerals to numeral “0”, as depicted by the list of items 114, i.e. numerals, displayed on the display 106. The marked numeral “0” can then be selected by e.g. pressing a select key 116 arranged in the center of the rotator input 104.

FIG. 2 schematically shows a mobile communication apparatus 200 comprising a user interface UI 202 with a rotator input 204 and a display 206 according to an embodiment of the present invention. The rotator input 204 is divided into eight areas 208 and comprises means for determining in which area the user starts to actuate the rotator input 204. Depending on the area in which the user starts to actuate the rotator input 204, and the amount of actuation, i.e. the angular movement detected by the rotator input 204, navigation is performed among items. In the example illustrated by the mobile communication apparatus 200 in FIG. 2, a text 210 is input by using the rotator input 204, which is divided into eight areas 208, each associated with a set of characters, here according to the postitions on a QWERTY keyboard. Here, the user has started actuating the rotator input 204 in the area 212 associated with characters “YUIOP” and navigated among these characters to character “P”, as depicted by the list of items 214, i.e. characters, displayed on the display 206. The marked character “P” can then be selected by e.g. pressing a select key 216 arranged in the center of the rotator input 204.

The user interfaces 102, 202 of the mobile communication apparatuses 100, 200 illustrated in FIGS. 1 and 2 can comprise further input means (not shown), such as microphone, keys, joystick, camera, etc, and further output means (not shown), such as a secondary display, speaker, vibrator, etc. However, they do not form part of the core of the invention, and, therefore, further description of these UI means is omitted.

The embodiments illustrated in FIG. 1 and FIG. 2 are examples, but numerous of other examples with different number of areas and different types of characters can be employed. Further, the plurality of areas can be associated with different sets of operations. For example, each area can be associated with a set of applications to be accessed, e.g. one area for messaging, one area for contacts, another area for settings, etc. Thereby, fast access to a great number of applications can be provided. The user starts actuation at the area associated with the type of applications to be accessed, and navigates to the wanted application by an angular movement with the rotator input.

The information associated with the areas can be printed or dynamically displayed on or under the rotator input. Dynamic display can be performed by backlighting the actual information, or by arranging a display on or under the rotary input. The number of areas can be assigned dynamically, or be fixed.

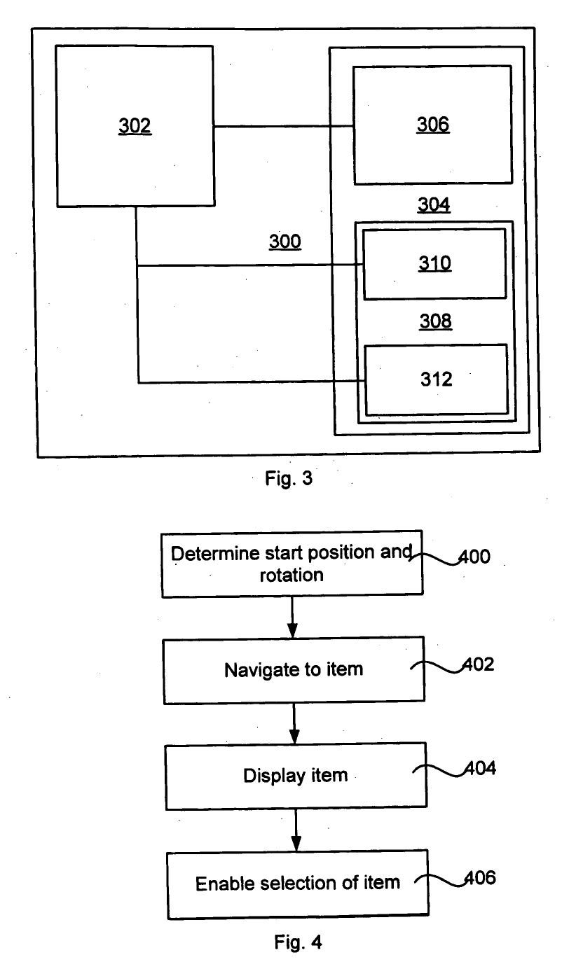

FIG. 3 is a schematic block diagram of a mobile communication apparatus 300. The mobile communication apparatus 300 comprises a processor 302 and a user interface UI 304. The user interface comprises a display 306 and a rotator input 308. The rotator input 308 comprises a first sensor means 310 for determining a starting position of actuation of the rotator input 308, and a second sensor means 312 for determining a rotation of the rotator input 308. The first and second sensor means 310, 312 should be construed functionally, and can be one common, or more elements.

The processor 302 is arranged to control a plurality of functions of the mobile communication apparatus 300. Not to obscure the core of the invention in this description, only parts related to the invention is described. However, as an artisan is well up in, a plurality of other features, functions, and elements of the mobile communication apparatus may be comprised. The processor 302 is arranged to receive output signals from the first and second sensors 310, 312, indicating where on the rotator input 308 a user starts to actuate the rotator input, and an amount of rotation of the rotator input 308. The processor 302 processes the signals according to a function and navigation among a plurality of items to an item is performed under control of the processor 302. The processor 302 is connected to the display 306, and the item is displayed under control of the processor 302 on the display 306. Preferably, a subset of items associated with an area of the rotator input 308 within which the actuation starts is displayed, and the item according to the navigation by the rotation on the rotator input 308 is preferably indicated in the subset of items. The UI 304 can comprise one or more selection keys (not shown) which the user can press to select the item which has been navigated to. The selected item is used as input.

FIG. 4 is a flow chart illustrating an input method for a mobile communication apparatus with a rotator input according to an embodiment of the present invention. In a start position and rotation determination step 400, a starting position on said rotator input where a user starts actuating the rotator input, and rotation of the rotator input is determined. Based on a function of the starting position and rotation, navigation is performed among a plurality of items in a navigation step 402. The item, which has been the target for navigation, is displayed in an item display step 404. A user may be enabled to select the item in a item selection enabling step 406. Alternatively, e.g. when navigation only is used for a viewer or for viewing a presentation, no selection is to be performed.

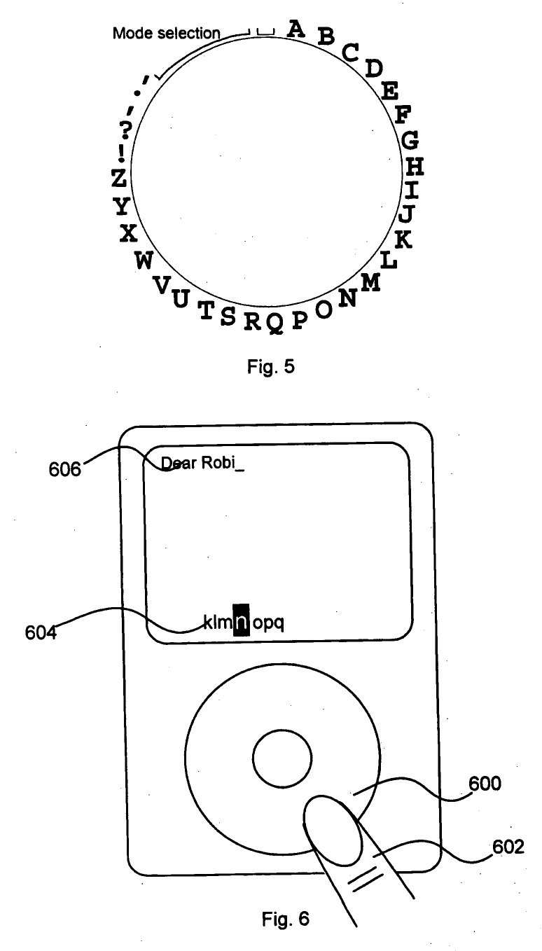

An approach of the present invention is to assign a character to each position of the rotator input, e.g. as illustrated in FIG. 5, and let the user start actuating the rotator input 600, as illustrated in FIG. 6, with her finger 602 at an approximate position of a character. A character bar 604 on the display shows the assigned characters located around the starting point of actuation, and preferably, the most probable character is highlighted. The user can then adjust the highlight position by rotating the rotator input to select a character to input. The most probable character can be determined from the starting position of the actuation and previously input characters 606. The probability dependency from previously input characters can utilize a dictionary.

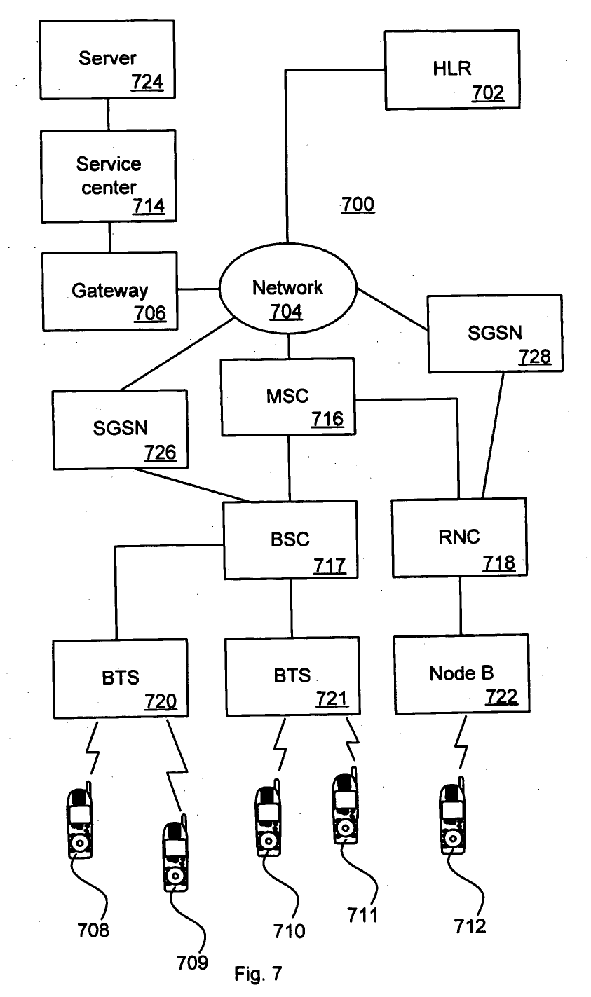

FIG. 7 shows a mobile communication system 700 according to an embodiment of the present invention. A Home Location Register (HLR) 702 contains a database (not shown) including relevant subscriber information for provision of telecommunication service. A CCITT specified network 704 interconnects the individual parts of the system 700. A gateway 706 is a switching unit routing a service to a mobile communication apparatus 708-712. A Service Center 714 (SC) and the gateway 706 handles and routes traffic between the SC 714 and the network 704. From the network 704, the traffic are routed to the mobile communication apparatuses 708-712 via a Mobile Switching Center (MSC) 716 to a Base Station Controller (BSC) 717 and a Base Transceiver Station (BTS) 720, 721, or a Radio Network Controller (RNC) 718 and a Node B 722. Alternatively, the traffic are routed to the mobile communication apparatuses 708-712 via a Serving GPRS Support Node (SGSN) 726, 728 to the BSC 717 and the BTS 720, 721, or the RNC 718 and the Node. B 722, respectively. The BTS 720, 721 and/or the Node B 722 establish the air connection to the mobile communication apparatuses 708-712. The invention has mainly been described above with reference to a few embodiments. However, as is readily appreciated by a person skilled in the art, other embodiments than the ones disclosed above are equally possible within the scope of the invention, as defined by the appended patent claims.

1. A mobile communication apparatus, comprising a processor and a user interface UI connected to said processor, wherein
said UI comprises a rotator input comprising a first sensor means comprising an output providing a start signal indicating where on the rotator input a user starts to actuate said rotator input, and a second sensor means comprising an output providing a rotation signal indicating an amount of rotation of said rotator input;
said processor is arranged to navigate to an item of a plurality of items in said UI according to a function of said start signal and said rotation signal; and
said UI further comprises a display on which said item is presented.

2. The mobile communication apparatus according to claim 1, wherein said rotator input is divided into a plurality of sectors, wherein each sector is associated with a start signal.

3. The mobile communication apparatus according to claim 1, wherein said first sensor means is touch sensitive.

4. The mobile communication apparatus according to claim 1, wherein said function comprises a subfunction of said start signal indicating a starting point in a list of items, and said rotation signal indicating a number of steps from said starting point in said list.

5. The mobile communication apparatus according to claim 4, wherein items are characters to be selected for input of characters.

6. The mobile communication apparatus according to claim 5, wherein said subfunction of said start signal determines a most probable character to be input to be said starting point of said list of items.

7. The mobile communication apparatus according to claim 6, wherein said most probable character is determined from said start signal and previously input characters.

8. The mobile communication apparatus according to claim 1, wherein said function comprises a subfunction of said start signal indicating a scrolling speed among items, and said rotation signal indicating an amount of scrolling according to said scrolling speed.

9. The mobile communication apparatus according to claim 1, wherein said function comprises a subfunction of said start signal indicating an operation mode.

10. The mobile communication apparatus according to claim 1, wherein said UI is arranged to display a sub-set of said plurality of items, wherein said sub-set is associated with a value of said start signal.

11. A method for input with a rotator input of a user interface UI of a mobile communication apparatus, comprising the steps of:
determining a starting position on said rotator input where a user starts actuating said rotator input, and rotation of said rotator input;
navigating to an item of a plurality of items of said UI according to a function of said starting position and said rotation; and
displaying said item.

12. The method according to claim 10, wherein said function comprises a subfunction of said start signal indicating a starting point in a list of items, and said rotation signal indicating a number of steps from said starting point in said list.

13. The method according to claim 12, wherein items are characters to be selected for input of characters and said subfunction of said start signal determines a most probable character to be input to be said starting point of said list of items.

14. The method according to claim 13, wherein said most probable character is determined from said start signal and previously input characters.

15. The method according to claim 12, wherein said plurality of items are characters, further comprising the steps of selecting a character; and using the selected character as input.

16. The method according to claim 11, wherein said function comprises a subfunction of said start signal indicating a scrolling speed among said plurality of items, and said rotation signal indicating an amount of scrolling according to said scrolling speed.

17. The method according to claim 11, wherein said function comprises a subfunction of said start signal indicating an operation mode.

18. The method according to claim 11, further comprising the step of enabling a user to select the displayed item.

19. The method according to claim 11, further comprising the step of displaying a sub-set of said plurality of items, wherein said sub-set depends on said starting position.

20. A mobile communication system comprising a network and a plurality of mobile communication apparatuses wirelessly being in communication with said network, wherein at least one of said mobile communication apparatuses comprises a processor and a user interface UI connected to said processor, wherein
said UI comprises a rotator input comprising a first sensor means comprising an output providing a start signal indicating where on the rotator input a user starts to actuate said rotator input, and a second sensor means comprising an output providing a rotation signal indicating an amount of rotation of said rotator input;
said processor is arranged to navigate to an item of a plurality of items in said UI according to a function of said start signal and said rotation signal; and
said UI further comprises a display on which said item is presented.

21. The system according to claim 20, wherein said rotator input is divided into a plurality of sectors, wherein each sector is associated with a start signal.

22. The system according to claim 20, wherein said first sensor means is touch sensitive.

23. The system according to claim 20, wherein said function comprises a subfunction of said start signal indicating a starting point in a list of items, and said rotation signal indicating a number of steps from said starting point in said list.

24. The system according to claim 23, wherein items are characters to be selected for input of characters.

25. The system according to claim 24, wherein said subfunction of said start signal determines a most probable character to be input to be said starting point of said list of items.

26. The system according to claim 25, wherein said most probable character is determined from said start signal and previously input characters.
